(19) United States
(12) Patent Application Publication
(10) Pub. No.: US 2024/0411851 A1
(43) Pub. Date: Dec. 12, 2024

(54) Authentication system, request apparatus, response apparatus, request method, and response method

(71) Applicant: CPMasterpiece Co. Ltd., Hong Kong (HK)

(72) Inventors: MING YIP WALLACE WONG, Hong Kong (HK); CHUN TO WONG, Hong Kong (HK)

(21) Appl. No.: 18/811,678

(22) Filed: Aug. 21, 2024

Related U.S. Application Data
(63) Continuation of application No. 16/713,740, filed on Dec. 13, 2019.

(51) Int. Cl. G06F 21/36; G06Q 10/08; G06Q 20/40; G06T 15/00; H04B 10/116; H04B 11/00

(52) U.S. Cl. CPC G06F 21/36; G06Q 10/08; G06Q 20/40; G06T 15/005; H04B 10/116; H04B 11/00

(57) ABSTRACT

An authentication system includes a request apparatus. The request apparatus includes a generation module, configured to generate a three-dimensional image or a multi-dimensional image. The three-dimensional image or the multi-dimensional image is configured for the authentication of the three-dimensional image or multi-dimensional image. The invention also provides a request apparatus, a response device, a request method and a response method. The authentication system, the request apparatus, the response apparatus, the request method and the response method provided by the invention can perform identity verification by three-dimensional images or multi-dimensional images, thereby avoiding leakage of verification information and ensuring financial security and information security of the user.

### CROSS REFERENCE TO RELATED APPLICATIONS

This application is a continuation of the U.S. application Ser. No. 16/713,740 filed on 13 Dec. 2019, entitled “AUTHENTICATION SYSTEM, REQUEST APPARATUS, RESPONSE APPARATUS, REQUEST METHOD, AND RESPONSE METHOD,” which is a continuation of International Patent Application No. PCT/CN2018/110809, filed on 18 Oct. 2018, which claims the benefit and priority of Hong Kong patent application Ser. No. 17/110,700.1.4, filed on 20 Oct. 2017, the disclosures of which are incorporated herein by reference in their entireties.

### TECHNICAL FIELD

The present invention relates to the field of communications, and in particular to an authentication system, a request apparatus, a response apparatus, a request method, and a response method.

### BACKGROUND

With the development of e-commerce technology, many customers are accustomed to the online shopping. And online ordering and online payment become daily habits. The goods ordered are delivered to home by courier, or the merchant places the goods in the designated place and the customer collects them. In the existing online shopping mode, the merchant and the customer display the picture and the two-dimensional code in the electronic order through the smart device for identity verification. But the manner of displaying the picture and the two-dimensional code is unsafe. For example, after others use the mobile phone to take pictures and QR codes for verification, they can also perform identity verification, which cannot ensure the customer's shopping safety and financial security.

### SUMMARY

In view of this, an object of the present invention is to provide an authentication system that can avoid leaking verification information and ensure financial security and information security of users.
the present invention provides an authentication system, comprising a request apparatus, wherein the request apparatus comprises a generation module, configured to generate a three-dimensional image or a multi-dimensional image; the three-dimensional image or the multi-dimensional image is configured for the authentication of the three-dimensional image or multi-dimensional image.

Preferably, the authentication system further comprises a response apparatus, wherein the request apparatus includes a verification module, configured to acquire the three-dimensional image and verify the three-dimensional image, or to acquire the multi-dimensional image and verify the multi-dimensional image.

Preferably, the verification module of the request apparatus is further configured to match the three-dimensional image or the multi-dimensional image with data in a database, and if the three-dimensional image or the multi-dimensional image matches the data in the database successfully, the authentication is successful.

Preferably, the response apparatus further comprises a parallax barrier, a microlens, a display, wherein the parallax barrier and the microlens are configured to split the light form an image displayed on the display to generate a plurality of different pictures;
the request apparatus includes a plurality of cameras, wherein the plurality of cameras are installed at different positions in space, the shooting angles of the plurality of cameras are set to different from each other, and the plurality of cameras are configured to respectively acquire the generated plurality of different pictures;
the request apparatus further includes a processor, configured to generate a three-dimensional image or a multi-dimensional image according to the acquired plurality of different pictures, and verify the generated three-dimensional image or country multi-dimensional image.

Preferably, the response apparatus further comprises a device protecting a screen, wherein the parallax barrier and the microlens are uniformly mounted on the device protecting a screen, or the parallax barrier and the microlens are mounted in a partial area of the device protecting a screen.

Preferably, the parallax barrier and the microlens of the response apparatus are configured to divide a picture displayed by the display into two or more pictures, wherein each of the divided pictures includes different encoded information, and the divided pictures are used as multiple levels of security password;
the processor of the request apparatus is further configured to acquire the plurality of the divided pictures, determine whether the acquired pictures can piece into a complete three-dimensional image or a complete multi-dimensional image, when the acquired pictures can piece into a complete three-dimensional image or a complete multi-dimensional image, decode the acquired pictures to acquire decoding information of the acquired pictures, and match the decoding information with the data in the database; when the matching is successful, the authentication is successful.

Preferably, the processor of the request apparatus is further configured to: when the acquired pictures cannot piece into a complete three-dimensional image or a complete multi-dimensional image, determine that the authentication fails.

The present invention provides another authentication system, comprising a request apparatus and a response apparatus, wherein
the request apparatus comprises a request module, configured to send a request code to the response apparatus;
the response apparatus comprises a front camera or a proximity sensor, configured to receive the request code, generate and display one or more response pictures to the request apparatus, wherein the response picture is generated according to the request code, and the response picture is a three-dimensional image or a multi-dimensional image;
the request apparatus further comprises a verification module, configured to acquire the three-dimensional image or the multi-dimensional image, and match the three-dimensional image or the multi-dimensional image with the data in the database; if the three-dimensional image or the multi-dimensional image matches the data in the database successfully, the authentication is successful; wherein
the response apparatus further comprises a parallax barrier and a microlens, configured to split light form an image displayed by the display to generate a plurality of different pictures;
the request apparatus further comprises a plurality of cameras, wherein the plurality of cameras are installed at different positions in space, the shooting angles of the plurality of cameras are set to different from each other, and the plurality of cameras are configured to respectively acquire the generated plurality of different pictures;
the request apparatus further comprises a processor, configured to generate a three-dimensional image or a multi-dimensional image according to the acquired plurality of different pictures, and verify the generated three-dimensional image or multi-dimensional image;
the parallax barrier and the microlens of the response apparatus are further configured to divide a picture displayed by the display into two or more pictures, wherein each of the divided pictures includes different encoded information; the divided pictures are used as multiple levels of security password;
the processor of the request apparatus is further configured to acquire the divided plurality of pictures, determine whether the acquired pictures can piece into a complete three-dimensional image or a complete multi-dimensional image, when the acquired pictures can piece into a complete three-dimensional image or a complete multi-dimensional image, decode the acquired pictures to acquire decoding information of the acquired pictures, and match the decoding information of the acquired pictures with the data in the database; when the matching is successful, the authentication is successful; when the acquired pictures cannot piece into a complete three-dimensional image or a complete multi-dimensional image, determine that the authentication fails; wherein the encoded information includes one or more numbers or characters; the number includes a digital watermark displayed by a device protecting a screen of the response apparatus, and a password code that is input or encoded, wherein the password code includes a picture or a two-dimensional code;
the display of the response apparatus is configured to rotate the displayed picture to align the displayed picture with the parallax barrier or the microlens;
the response apparatus further includes a player, configured to play a sound with encoded information;
the processor of the request apparatus is further configured to receive the sound with encoded information, decode the sound to obtain decoding information of the sound, integrate the decoding information of the sound and the decoding information of the acquired pictures to obtain first verification information after the integration, and match the first verification information with the data in the database; when the matching is successful, the authentication is successful;
the response apparatus further comprises a flashlight, configured to emit a light source carrying security information;
the processor of the request apparatus is further configured to receive the light source carrying security information, decode the light source carrying the security information to obtain decoding information of the light source, integrate the decoding information of the light source and the decoding information of the acquired pictures to obtain second verification information, and match the second verification information with the data in the database; when the matching is successful, the authentication is successful;
the processor of the request apparatus is further configured to integrate the decoding information of the acquired pictures, the decoding information of the sound, and the decoding information of the light source to obtain third verification information, and match the third verification information with the data in the database; and when the matching is successful, the authentication is successful.

The present invention provides a request apparatus, wherein the request apparatus is in communication with the response apparatus, and the request apparatus comprises:
a request module, configured to send a request code to the response apparatus;
a verification module, configured to acquire a three-dimensional image or a multi-dimensional image sent by the response apparatus, and match the three-dimensional image or the multi-dimensional image with data in a database; if the three-dimensional image or the multi-dimensional image matches the data in the database successfully, the verification is successful; wherein the three-dimensional image or the multi-dimensional image is a response picture generated according to the request code;
a plurality of cameras, the plurality of cameras are installed at different positions in space, the shooting angles of the plurality of cameras are set to different from each other, and the plurality of cameras are configured to acquire a plurality of different pictures, wherein the plurality of different pictures are photographed by a parallax barrier and a microlens of the response apparatus;
a processor, configured to generate a three-dimensional image or a multi-dimensional image according to the acquired plurality of different pictures, and verify the generated three-dimensional image or multi-dimensional image;
the processor is further configured to acquire a plurality of divided pictures generated by the response apparatus, wherein the plurality of divided pictures are two or more pictures obtained by dividing the picture displayed by the display by the parallax barrier and the microlens, wherein each of the divided pictures contains different encoded information, and the divided pictures are used as multiple levels of security password; and determine whether the acquired pictures can piece into a complete three-dimensional image or a complete multi-dimensional image, when the acquired pictures can piece into a complete three-dimensional image or a complete multi-dimensional image, decode the acquired pictures to obtain decoding information of the acquired pictures, and match the decoding information of the acquired picture with the data in the database; when the matching is successful, the authentication is successful;
the processor is further configured to: when the acquired pictures cannot piece into a complete three-dimensional image or a complete multi-dimensional image, determine that the verification fails, wherein the encoded information includes one or more numbers or characters, and the number includes a digital watermark displayed by a device protecting a screen of the response apparatus, and a password code that is input or encoded, wherein the password code includes a picture or a two-dimensional code;
the processor is further configured to receive a sound with encoded information sent by the response apparatus, decode the sound to obtain decoding information of the sound, integrate the decoding information of the sound and the decoding information of the acquired pictures to obtain first verification information, and match the first verification information with the data in the database; when the matching is successful, the authentication is successful;
the processor is further configured to receive a light source carrying the security information sent by the response apparatus, decode the light source carrying the security information to obtain decoding information of the light source, integrate the decoding information of the light source and the decoding information of the acquired pictures to obtain second verification information, and match the integrated second verification information with the data in the database; when the matching is successful, the authentication is successful;
the processor is further configured to integrate the decoding information of the acquired pictures, the decoding information of the sound, and the decoding information of the light source to obtain third verification information, and match the third verification information with the data in the database; when the matching is successful, the authentication is successful.

The present invention provides a response apparatus, being in communication with the request apparatus; the response apparatus comprises a display, wherein the response apparatus further comprises:
a front camera or proximity sensor, configured to receive a request code sent by the request apparatus, and generate and display one or more response pictures to the request apparatus, wherein the response picture is generated according to the request code; the response picture is a three-dimensional image or a multi-dimensional image;
a parallax barrier and a microlens, configured to split light from an image displayed by the display to generate a plurality of different pictures;
a device protecting a screen, uniformly mounting the parallax barrier and the microlens on the device protecting a screen, or mounting a parallax barrier and a microlens in a partial area of the device protecting a screen;
the parallax barrier and the microlens, are configured to divide the picture displayed by the display into two or more pictures, wherein each of the divided pictures includes different encoded information, and the divided pictures are used as multiple levels of security password;
the different encoded information includes one or more numbers or characters, the number including a digital watermark displayed on the device protecting a screen, and a password code input or encoded, wherein the password code includes a picture or a two-dimensional code;
the display is configured to rotate the displayed picture to align the displayed picture with the parallax barrier or the microlens;
the parallax barrier is configured to block light of a first preset wavelength;
a player is configured to play a sound with encoded information to the request apparatus;
a flashlight is configured to transmit a light source carrying security information to the request apparatus.

The present invention provides a request method, applied to a request apparatus, wherein the request apparatus is in communication connection with the response apparatus, wherein the method comprises:
sending a request code to the response apparatus by the request apparatus;
by the request apparatus, acquiring a three-dimensional image or a multi-dimensional image sent by the response apparatus, matching the three-dimensional image or the multi-dimensional image with the data in the database, and if the three-dimensional image or the multi-dimensional image is successfully matched with the data in the database, determining that the authentication is successful, wherein the three-dimensional image or the multi-dimensional image is a response picture generated according to the request code.

Alternatively, the request apparatus comprises a plurality of cameras, the plurality of cameras are installed in different positions in space, and the shooting angles of the plurality of cameras are set to different from each other; the method further comprises:
acquiring a plurality of different pictures by the plurality of cameras, wherein the plurality of different pictures are photographed by a parallax barrier and a microlens of the response apparatus;
by the request apparatus, generating a three-dimensional image or a multi-dimensional image according to the acquired plurality of different pictures, and verifying the generated three-dimensional image or the multi-dimensional image.

Alternatively, the method further comprises:
acquiring a plurality of divided pictures generated by the response apparatus by the request apparatus, wherein the plurality of divided pictures are two or more pictures obtained by dividing a picture displayed by the display by a parallax barrier and a microlens, wherein each of the divided pictures includes different encoded information, and the divided pictures are used as multiple levels of security password;
by the request apparatus, determining whether the acquired pictures can piece into a complete three-dimensional image or a complete multi-dimensional image, when the acquired pictures can piece into a complete three-dimensional image or a complete multi-dimensional image, decoding the acquired pictures to obtain decoding information of the acquired pictures, matching the decoding information of the acquired pictures with the data in the database, when the matching is successful, determining that the authentication is successful, and when the acquired picture cannot piece into a complete three-dimensional image or a complete multi-dimensional image, determining that the authentication fails, wherein the encoded information includes one or more numbers or characters, the number including a digital watermark displayed on the device protecting a screen of the response apparatus, and a password code input or encoded; wherein the password code includes a picture or two-dimensional code.

The present invention provides a response method, applied to a response apparatus, the response apparatus being in communicative connection with the request apparatus; the response apparatus comprises a display, a front camera, a proximity sensor, a parallax barrier and a microlens; the response method further comprises:
receiving, by the front camera or the proximity sensor, the request code sent by the request apparatus, generating and displaying one or more response pictures to the request apparatus, wherein the response picture is generated according to the request code, and the response picture is a three-dimensional image or a multi-dimensional image;
splitting light from an image displayed by the display by the parallax barrier and the microlens to produce a plurality of different pictures.

Preferably, the response apparatus comprises a device protecting a screen, and the response method further comprises:
mounting the parallax barrier and the microlens uniformly on the device protecting a screen, or mounting the parallax barrier and the microlens in a partial area of the device protecting a screen;
dividing the picture displayed by the display into two or more pictures by the parallax barrier and the microlens, wherein each of the divided pictures includes different encoded information, and the divided picture are used as multiple levels of security password;
wherein the different encoded information includes one or more numbers or characters, the number including a digital watermark displayed on the device protecting a screen, and a password code input or encoded, wherein the password code includes a picture or two-dimensional code.

The authentication system, the request apparatus, the response apparatus, the request method and the response method provided by the invention can perform identity verification through a three-dimensional image or a multi-dimensional image, and can be authenticated by using a sound with encoded information and a light source with encoded information to avoid leakage. And it can ensure users' financial security and information security.

The invention is described in detail below with reference to the drawings and embodiments.

### BRIEF DESCRIPTION OF THE DRAWINGS

FIG. 1 is a schematic diagram of an authentication system according to a first embodiment of the present invention;

FIG. 2 is a schematic diagram of an authentication system according to a second embodiment of the present invention;

FIG. 3 is a functional block diagram of a request apparatus according to a third embodiment of the present invention;

FIG. 4 is a functional block diagram of a response apparatus according to a fourth Embodiment of the present invention;

FIG. 5 is a flowchart of a request method according to a fifth embodiment of the present invention;

FIG. 6 is a flowchart of a response method according to a sixth embodiment of the present invention.

The invention will be further illustrated by the following detailed description in conjunction with the drawings.

### DETAILED DESCRIPTION OF EMBODIMENTS

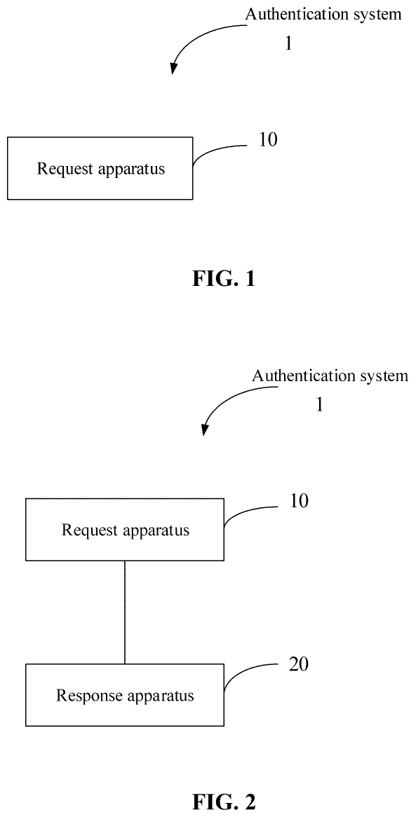

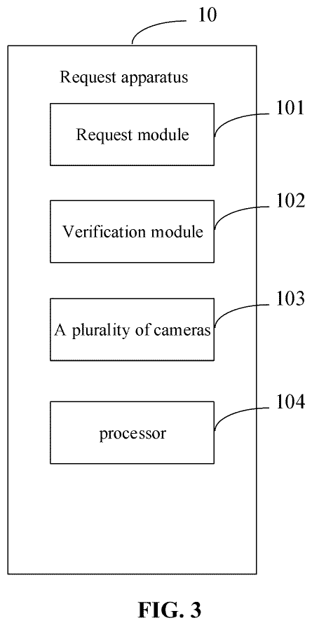

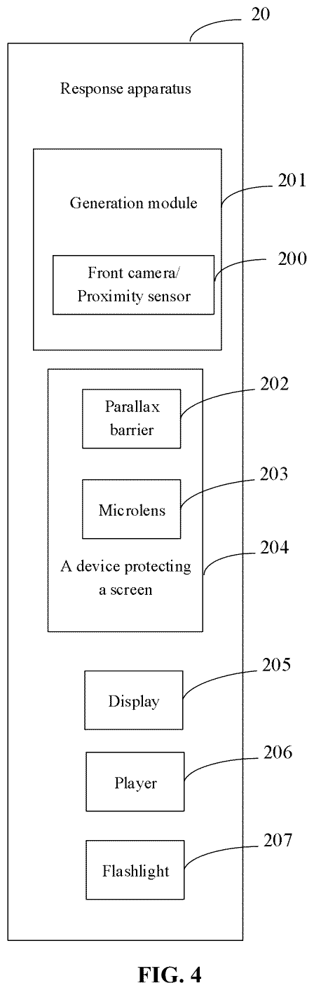

Referring to FIG. 1, FIG. 1 is a schematic diagram of an authentication system according to a first embodiment of the present invention. Referring to FIG. 2, FIG. 2 is a schematic diagram of an authentication system according to a second embodiment of the present invention. FIG. 3 is a functional block diagram of a request apparatus according to a third embodiment of the present invention. FIG. 4 is a functional block diagram of a response apparatus according to a fourth embodiment of the present invention. The details will be described below with reference to FIG. 1 to FIG. 4

The authentication system 1 in FIG. 1 includes a request apparatus 10, and the authentication system 1 in FIG. 2 includes a request apparatus 10 and a response apparatus 20. The request apparatus 10 in FIG. 3 includes a request module 101, a verification module 102, a plurality of cameras 103, and a processor 104. The response apparatus 20 of FIG. 4 includes a generation module 201, a front camera/proximity sensor 200, a parallax barrier 202, a microlens 203, a device protecting a screen 204, a display 205, a player 206, and a flashlight 207.

The generation module 201 of the response apparatus 20 generates a three-dimensional image or a multi-dimensional image, configured to the authentication of the three-dimensional image authentication or the multi-dimensional image.

The verification module 102 of the request apparatus 10 acquires a three-dimensional image or a multi-dimensional image and verifies the three-dimensional image or the multi-dimensional image.

Specifically, the verification module 102 of the request apparatus 10 matches the three-dimensional image or the multi-dimensional image with the data in the database, and if the three-dimensional image or the multi-dimensional image matches the data in the database successfully, determines that the verification is successful.

The parallax barrier 202 and the microlens 203 of the response apparatus 20 split light from an image displayed on the display to generate a plurality of different pictures. The plurality of cameras 103 of the request apparatus 10 are installed at different positions in space, the shooting angles of plurality of cameras are different from each other, and the plurality of cameras respectively acquire the generated of plurality of different pictures. The processor 104 of the request apparatus 10 also generates a three-dimensional image or a multi-dimensional image according to the acquired plurality of different pictures, and verifies the generated three-dimensional image or multi-dimensional image.

The response apparatus 20 further includes a device protecting a screen 204 on which the parallax barrier 202 and the microlens 203 are uniformly mounted. Or the parallax barrier 202 and the microlens 203 are mounted on a partial region of the device protecting a screen 204. The parallax barrier 202 and the microlens 203 of the response apparatus 20 divide the picture displayed on the display 205 into two or more pictures, wherein each of the divided pictures contains different encoded information, and the divided pictures are used as multiple levels of security password.

The processor 104 of the request apparatus 10 acquires the plurality of divided pictures, and determines whether the acquired pictures can piece into a complete three-dimensional image or a complete multi-dimensional image. When the acquired pictures can piece into a complete three-dimensional image or a complete multi-dimensional image, decodes the acquired picture to obtain decoding information of the acquired pictures, matches the decoding information of the acquired pictures with the data in the database. When the matching is successful, the authentication is successful. When the acquired pictures cannot piece into a complete three-dimensional image or a complete multi-dimensional image, the processor 104 of the request apparatus 10 determines that the authentication has failed. Wherein, the encoded information includes one or more numbers or characters, and the number includes a digital watermark displayed on the device protecting a screen, and a password code input or encoded, wherein the password code includes a picture or a two-dimensional code.

The display 205 of the response apparatus 20 rotates the displayed picture, and aligns the displayed picture with the parallax barrier 202 or the microlens 203. And the displayed picture can be continuously rotated. At least at a certain time of the rotation, the picture is aligned with the parallax barrier 202 or the microlens 203. The parallax barrier 202 of the response apparatus 20 blocks light of a first preset wavelength, the plurality of cameras 103 of the request apparatus 10 receives light of a second preset wavelength, wherein the light of the first preset wavelength and the light of the second preset wavelength are set according to your needs.

It is additionally noted that the player 206 of the response apparatus 20 plays a sound with encoded information. The processor 104 of the request apparatus 10 receives the sound with encoded information, decodes the sound to obtain decoding information of the sound, integrates the decoding information of the sound and the decoding information of the acquired pictures to obtain first verification information, and matches the first verification information with the data in the database. When the matching is successful, the authentication is successful.

Further, the response apparatus further includes a flashlight, configured to transmit a light source carrying security information, and the processor 104 of the request apparatus 10 receives the light source carrying the security information, decodes the light source carrying the security information to obtain decoding information of the light source. The decoding information of the light source and the decoding information of the acquired pictures are integrated to obtain second verification information, and the second verification information is matched with the data in the database. When the matching is successful, the authentication is successful.

It is further explained that the processor 104 of the request apparatus 10 integrates the decoding information of the acquired pictures, the decoding information of the sound, and the decoding information of the light source to obtain third verification information, and matches the third verification information with the data in the database. When the matching is successful, the authentication is successful.

The request module 101 of the request apparatus 10 sends a request code to the response apparatus; the front camera or proximity sensor 200 of the response apparatus 20 receives the request code, and generates and displays one or more response pictures to the request apparatus, wherein the response picture is generated according to the request code, and the response picture is a three-dimensional image.

Please refer to FIG. 3 again, and FIG. 3 is further described below. The request apparatus 10 includes a request module 101, a verification module 102, a plurality of cameras 103, and a processor 104. The request apparatus 10 is in communication connection with the response apparatus 20 shown in FIG. 4. The request module 101 sends a request code to the response apparatus 20. The verification module 102 acquires a three-dimensional image or a multi-dimensional image sent by the response apparatus 20, and matches the three-dimensional image or the multi-dimensional image with the data in the database. If the three-dimensional image or the multi-dimensional image matches the data in the database successfully, the authentication is successful, wherein the three-dimensional image or the multi-dimensional image is a response picture generated according to the request code. The plurality of cameras 103 are installed at different positions in space, the shooting angles of the plurality of cameras are set to different from each other, and the plurality of cameras 103 acquire a plurality of different pictures, wherein a plurality of different pictures are photographed by the parallax barrier and the microlens of the response apparatus. A plurality of cameras 103 is configured to respectively receive light of different preset wavelengths to generate different images. The processor 104 generates a three-dimensional image or a multi-dimensional image according to the acquired plurality of pictures, and verifies the generated three-dimensional image or multi-dimensional image.

In addition, acquires a plurality of divided pictures generated by the response apparatus, wherein the plurality of divided pictures are two or more pictures obtained by dividing the picture displayed by the display by the parallax barrier and the microlens, wherein each divided picture contains different encoded information, and the divided pictures are used as multiple levels of security password. And the processor 104 determines whether the acquired pictures can piece into a complete three-dimensional image or a complete multi-dimensional image. When the acquired pictures can piece into a complete three-dimensional image or a complete multi-dimensional image, decode the acquired picture to obtain decoding information of the acquired pictures, and match the decoding information of the acquired pictures with the data in the database. When the matching is successful, the authentication is successful. When the acquired pictures cannot piece into a complete three-dimensional image or a complete multi-dimensional image, the processor 104 determines that the verification fails, wherein the encoded information includes one or more numbers or characters, and the number includes a digital watermark displayed on the device protecting a screen of the response apparatus, and a password code that is input or encoded, wherein the password code includes a picture or a two-dimensional code.

It should be noted that the processor 104 further receives sound with encoded information sent by the response apparatus, decodes the sound to obtain decoding information of the sound, integrates the decoding information of the sound and the decoding information of the acquired picture to obtain first verification information, and matches the first verification information with the data in the database. When the matching is successful, the authentication is successful.

Further, the processor 104 receives a light source carrying security information sent by the response apparatus, decodes the light source carrying the security information to obtain decoding information of the light source, integrates the decoding information of the light source and the decoding information of the acquired pictures to obtain second verification information after integration, and matches the integrated second verification information with the data in the database. When the matching is successful, the authentication is successful.

It is further explained that the processor 104 further integrates the decoding information of the acquired pictures, the decoding information of the sound, and the decoding information of the light source to obtain third verification information, and matches the integrated third verification information with the data in the database. When the match is successful, the authentication is successful.

Please refer to FIG. 4 again, and FIG. 4 is further described below. The response apparatus 20 specifically includes a generation module 201, a parallax barrier 202, a microlens 203, a device protecting a screen 204, a display 205, a player 206, and a flashlight 207. The generation module 201 includes a front camera/proximity sensor 200.

The response apparatus 20 is in communication connection with the request device 10 shown in FIG. 3; the front camera or proximity sensor 200 receives a request code sent by the request apparatus 10, and generates and displays one or more response pictures to the request apparatus, wherein the response picture is generated according to the request code, and the response picture is a three-dimensional image or a multi-dimensional image. The parallax barrier 202 and the microlens 203 split light from the image displayed by the display 205 to generate a plurality of different pictures. The parallax barrier 202 and the microlens 203 are uniformly mounted on the device protecting a screen 204, or the parallax barrier 202 and the microlens 203 are mounted in a partial region of the device protecting a screen 204.

The parallax barrier 202 and the microlens 203 divide the picture displayed by the display 205 into two or more pictures, wherein each of the divided pictures contains different encoded information, and the divided pictures are used as multiple levels of security password; the encoded information includes one or more numbers or characters; the numbers includes a digital watermark displayed on the device protecting a screen, and a password code that is input or encoded, wherein the password code includes a picture or a two-dimensional code.

The display 205 rotates the displayed picture to align the displayed picture with the parallax barrier or microlens. The parallax barrier 202 blocks light of a first preset wavelength. The player 206 plays the sound with encoded information to the request apparatus 10. The flashlight 207 emits a light source carrying security information to the request apparatus 10.

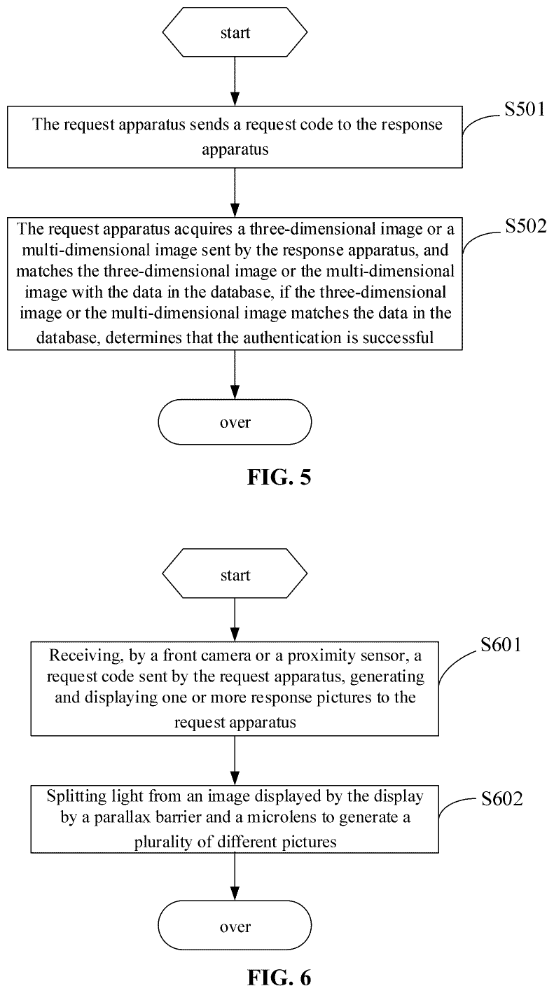

Referring to FIG. 5, FIG. 5 is a flowchart of a request method according to a fifth embodiment of the present invention. The present embodiment will be described in detail below.

In this embodiment, the request method is applied to the request apparatus, and the request apparatus is in communication connection with the response device, wherein the request apparatus may be the request apparatus in the foregoing embodiment, and the response apparatus may be the response apparatus in the foregoing embodiment.
Step S501: The request apparatus sends a request code to the response apparatus.

In this embodiment, the communication connection can be established between the request apparatus and the response apparatus by means of Wi-Fi or near field communication.
Step S502: The request apparatus acquires a three-dimensional image or a multi-dimensional image sent by the response apparatus, and matches the three-dimensional image or the multi-dimensional image with the data in the database, if the three-dimensional image or the multi-dimensional image matches the data in the database, determines that the authentication is successful, wherein the three-dimensional image or the multi-dimensional image is a response picture generated according to the request code.

In addition, the request apparatus includes a plurality of cameras, and the plurality of cameras are installed at different positions in space, the shooting angles of the plurality of cameras are set to different from each other, and a plurality of different pictures are acquired by the plurality of cameras, wherein the plurality of different pictures are photographed by a parallax barrier and a microlens of the response apparatus.

It is further added that the request apparatus generates a three-dimensional image or a multi-dimensional image according to the acquired plurality of different pictures, and verifies the generated three-dimensional image or the multi-dimensional image. The request apparatus acquires a plurality of divided pictures generated by the response apparatus, wherein the plurality of divided pictures are two or more pictures obtained by dividing the picture displayed by the display by the parallax barrier and the microlens, wherein each of the divided pictures includes different encoded information, and the divided pictures are used as multiple levels of security password. The request apparatus determines whether the acquired pictures can piece into a complete three-dimensional image or a complete multi-dimensional image, when the acquired picture can piece into a complete three-dimensional image or a complete multi-dimensional image, decodes the acquired picture to obtain decoding information of the acquired picture, and matches the decoding information of the acquired picture with the data in the database. And when the matching is successful, the authentication is successful.

When the acquired picture cannot piece into a complete three-dimensional image or a complete multi-dimensional image, the request apparatus determines that the authentication has failed. It should be noted that the different encoded information includes one or more numbers or characters, and the number includes a digital watermark displayed on the device protecting a screen of the response apparatus, and a password code input or encoded, wherein the password code includes a picture or a two-dimensional code.

Optionally, in this embodiment, the request apparatus receives the sound with the encoded information sent by the response apparatus, decodes the sound to obtain decoding information of the sound, integrates the decoding information of the sound and the decoding information of the acquired pictures to obtain first verification information, and matches the first verification information with the data in the database. When the matching is successful, the verification is successful.

Optionally, in this embodiment, the request apparatus receives the light source carrying security information sent by the response apparatus, decodes the light source carrying security information to obtain decoding information of the light source, integrates the decoding information of the light source and the decoding information of the acquired pictures to obtain second verification information, and matches the integrated second verification information with the data in the database. When the matching is successful, the authentication is successful.

Optionally, in this embodiment, the request apparatus integrates the decoding information of the acquired pictures, the decoding information of the sound, and the decoding information of the light source to obtain third verification information, and matches the integrated third verification information with the data in the database. When the matching is successful, the authentication is successful.

Referring to FIG. 6, FIG. 6 is a flowchart of a response method according to a sixth embodiment of the present invention. The present embodiment will be described in detail below.

In this embodiment, the response method is applied to the response apparatus, and the response apparatus is in communication connection with the request apparatus, wherein the request apparatus may be the request apparatus in the foregoing embodiment, and the response apparatus may be the response apparatus in the foregoing embodiment. The response apparatus includes a display, the response apparatus further including a front camera or a proximity sensor, the response apparatus further including a parallax barrier and a microlens.
Step S601: Receiving, by a front camera or a proximity sensor, a request code sent by the request apparatus, generating and displaying one or more response pictures to the request apparatus, where the response picture is generated according to the request code, and the response picture is a three-dimensional image or a multi-dimensional image.
Step S602: Splitting light from an image displayed by the display by a parallax barrier and a microlens to generate a plurality of different pictures.

In addition, in the embodiment, the response apparatus includes a device protecting a screen, the parallax barrier and the microlens are uniformly mounted on the device protecting a screen or in a partial area of the device protecting a screen. The response method further includes: dividing, by the parallax barrier and the microlens, the picture displayed by the display into two or more pictures, wherein each of the divided pictures includes different encoded information, and the divided picture are used as multiple levels of security password.

The different encoded information includes one or more numbers or characters, the number including a digital watermark displayed on the device protecting a screen, and a password code input or encoded, wherein the password code includes a picture or a two-dimensional code.

Optionally, in this embodiment, the response apparatus includes a display; by the display, rotating the displayed picture and aligning the displayed picture with the parallax barrier or the microlens. In this embodiment, the response method further comprises: blocking, by the parallax barrier, light of a first preset wavelength. The response apparatus further includes a player and a flashlight, and the response method further comprises: playing the sound with encoded information to the request apparatus by the player, and transmitting the light source carrying security information to the request apparatus by the flashlight.

The authentication system, the request apparatus, the response apparatus, the request method, and the response method provided by the invention can perform identity verification through a three-dimensional image or a multi-dimensional image, and can be authenticated by using a sound with encoded information and a light source with encoded information to avoid leakage. And it can ensure users' financial security and information security.

The above embodiments are not intended to limit the scope of the invention. Any modifications, equivalent substitutions and improvements made within the spirit and scope of the invention are intended to be included within the scope of the invention.

What is claimed is:

1. An authentication system, comprising a request apparatus, wherein the request apparatus is in communication with a response apparatus; the request apparatus comprises a generation module, configured to generate a three-dimensional image or a multi-dimensional image; the three-dimensional image or the multi-dimensional image is configured for the authentication of the three-dimensional image or multi-dimensional image.

2. The authentication system according to claim 1, wherein the request apparatus comprises:
a request module, configured to send a request code to the response apparatus;
a verification module, configured to acquire a three-dimensional image or a multi-dimensional image sent by the response apparatus, and match the three-dimensional image or the multi-dimensional image with data in a database; if the three-dimensional image or the multi-dimensional image matches the data in the database successfully, the verification is successful; wherein the three-dimensional image or the multi-dimensional image is a response picture generated according to the request code;
a plurality of cameras, the plurality of cameras are installed at different positions in space, the shooting angles of the plurality of cameras are set to different from each other, and the plurality of cameras are configured to acquire a plurality of different pictures, wherein the plurality of different pictures are photographed by a parallax barrier and a microlens of the response apparatus; and
a processor, configured to generate a three-dimensional image or a multi-dimensional image according to the acquired plurality of different pictures, and verify the generated three-dimensional image or multi-dimensional image.

3. The authentication system according to claim 2, wherein the processor is further configured to acquire a plurality of divided pictures generated by the response apparatus, wherein the plurality of divided pictures are two or more pictures obtained by dividing the picture displayed by a display by and the microlens, wherein each of the divided pictures contains different encoded information, and the divided pictures are used as multiple levels of security password; and determine whether the acquired pictures can piece into a complete three-dimensional image or a complete multi-dimensional image, when the acquired pictures can piece into a complete three-dimensional image or a complete multi-dimensional image, decode the acquired pictures to obtain decoding information of the acquired pictures, and match the decoding information of the acquired picture with the data in the database; when the matching is successful, the authentication is successful.

4. The authentication system according to claim 3, wherein the processor is further configured to: when the acquired pictures cannot piece into a complete three-dimensional image or a complete multi-dimensional image, determine that the verification fails, wherein the encoded information includes one or more numbers or characters, and the number includes a digital watermark displayed by a device protecting a screen of the response apparatus, and a password code that is input or encoded, wherein the password code includes a picture or a two-dimensional code.

5. The authentication system according to claim 4, wherein the processor is further configured to receive a sound with encoded information sent by the response apparatus, decode the sound to obtain decoding information of the sound, integrate the decoding information of the sound and the decoding information of the acquired pictures to obtain first verification information, and match the first verification information with the data in the database; when the matching is successful, the authentication is successful.

6. The authentication system according to claim 5, wherein the processor is further configured to receive a light source carrying security information sent by the response apparatus, decode the light source carrying the security information to obtain decoding information of the light source, integrate the decoding information of the light source and the decoding information of the acquired pictures to obtain second verification information, and match the integrated second verification information with the data in the database; when the matching is successful, the authentication is successful.

7. The authentication system according to claim 6, wherein the processor is further configured to integrate the decoding information of the acquired pictures, the decoding information of the sound, and the decoding information of the light source to obtain third verification information, and match the third verification information with the data in the database; when the matching is successful, the authentication is successful.

8. An authentication system, wherein the authentication comprises a response apparatus; the response apparatus is in communication with a request apparatus;
wherein the response apparatus comprises a verification module, configured to acquire the three-dimensional image and verify the three-dimensional image, or to acquire the multi-dimensional image and verify the multi-dimensional image;
a display;
a front camera or proximity sensor, configured to receive a request code sent by the request apparatus, and generate and display one or more response pictures to the request apparatus, wherein the response picture is generated according to the request code; the response picture is a three-dimensional image or a multi-dimensional image;
a parallax barrier and a microlens, configured to split light from an image displayed by the display to generate a plurality of different pictures;
a device protecting a screen, uniformly mounting the parallax barrier and the microlens on the device protecting a screen, or mounting a parallax barrier and a microlens in a partial area of the device protecting a screen.

9. The authentication system according to claim 8, wherein the parallax barrier and the microlens, are configured to divide the picture displayed by the display into two or more pictures, wherein each of the divided pictures includes different encoded information, and the divided pictures are used as multiple levels of security password.

10. The authentication system according to claim 9, wherein the different encoded information includes one or more numbers or characters, the number including a digital watermark displayed on the device protecting a screen, and a password code input or encoded, wherein the password code includes a picture or a two-dimensional code.

11. The authentication system according to claim 10, wherein the display is configured to rotate the displayed picture to align the displayed picture with the parallax barrier or the microlens; and the parallax barrier is configured to block light of a first preset wavelength.

12. The authentication system according to claim 11, wherein the response apparatus further comprises:
a player, configured to play a sound with encoded information to the request apparatus; and
a flashlight, configured to transmit a light source carrying security information to the request apparatus.

13. A request method, applied to a request apparatus, wherein the request apparatus is in communication with a response apparatus, wherein the method comprises:
sending a request code to the response apparatus by the request apparatus;
by the request apparatus, acquiring a three-dimensional image or a multi-dimensional image sent by the response apparatus, matching the three-dimensional image or the multi-dimensional image with the data in the database, and if the three-dimensional image or the multi-dimensional image is successfully matched with the data in the database, determining that the authentication is successful, wherein the three-dimensional image or the multi-dimensional image is a response picture generated according to the request code;
acquiring a plurality of divided pictures generated by the response apparatus by the request apparatus, wherein the plurality of divided pictures are two or more pictures obtained by dividing a picture displayed by the display by a parallax barrier and a microlens, wherein each of the divided pictures includes different encoded information, and the divided pictures are used as multiple levels of security password;
by the request apparatus, determining whether the acquired pictures can piece into a complete three-dimensional image or a complete multi-dimensional image, when the acquired pictures can piece into a complete three-dimensional image or a complete multi-dimensional image, decoding the acquired pictures to obtain decoding information of the acquired pictures, matching the decoding information of the acquired pictures with the data in the database, when the matching is successful, determining that the authentication is successful, and when the acquired picture cannot piece into a complete three-dimensional image or a complete multi-dimensional image, determining that the authentication fails, wherein the encoded information includes one or more numbers or characters, the number including a digital watermark displayed on the device protecting a screen of the response apparatus, and a password code input or encoded; wherein the password code includes a picture or two-dimensional code.

14. The request method according to claim 12, wherein the request apparatus comprises a plurality of cameras, the plurality of cameras are installed in different positions in space, and the shooting angles of the plurality of cameras are set to different from each other; the method further comprises:
acquiring a plurality of different pictures by the plurality of cameras, wherein the plurality of different pictures are photographed by a parallax barrier and a microlens of the response apparatus;
by the request apparatus, generating a three-dimensional image or a multi-dimensional image according to the acquired plurality of different pictures, and verifying the generated three-dimensional image or the multi-dimensional image.
